(19) United States
(12) Patent Application Publication
(10) Pub. No.: US 2025/0207412 A1
(43) Pub. Date: Jun. 26, 2025

(54) CEMENTITIOUS OVERLAYS AND METHODS FOR APPLICATION

(71) Applicant: Premier Overlay LLC, Fall City, WA (US)

(72) Inventors: Sean Hansen, Bellevue, WA (US); Tracy Lawrence Miller, Long Beach, WA (US)

(73) Assignee: Premier Overlay LLC, Fall City, WA (US)

(21) Appl. No.: 19/001,991

(22) Filed: Dec. 26, 2024

Related U.S. Application Data
(60) Provisional application No. 63/614,799, filed on Dec. 26, 2023.

(51) Int. Cl. E04F 15/12; C04B 28/02; C04B 28/06; C04B 41/48; C04B 103/54; C04B 111/62

(52) U.S. Cl. CPC E04F 15/12; C04B 28/02; C04B 28/06; C04B 41/4892; C04B 2103/54; C04B 2111/62

(57) ABSTRACT

Cementitious overlays and methods for application. Exemplary embodiments of the present disclosure use a “sandwich” structure. The sandwich of layers includes an epoxy layer to adhere to a substrate; the epoxy may be embedded with grit to provide sufficient physical texture for a cementitious layer to bond with. A cementitious layer is poured over the epoxy layer; the cementitious layer provides structural strength and rigidity. In some variants, the cementitious layer may also be aesthetically styled—the calcium aluminate cement (CAC) particle size allows for brushing and other fine detail manipulations which may be particularly important to achieve organic, flow-like patterns. Finally, the topmost layer of the sandwich uses a sealant or epoxy to protect the underlying cementitious layer. The topmost layer may be clear or may add layers of additional colors or other visual effects (glitter, metallic foils, etc.).

### PRIORITY

This application claims the benefit of priority to U.S. Provisional Patent Application Ser. No. 63/614,799 filed Dec. 26, 2023 and entitled “METHODS FOR APPLYING CEMENTITIOUS OVERLAYS”, incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of flooring overlays. More particularly, the present disclosure relates to cementitious overlays and methods of application.

### DESCRIPTION OF RELATED TECHNOLOGY

A flooring “overlay” is a layer of material over an existing floor substrate. Overlay techniques are often used to enhance or restore the appearance of a floor. Overlays can provide a fresh and updated look without complete removal and replacement of existing flooring. Flooring overlays are commonly applied to concrete floors but can also be used on other substrates like wood or tile.

There are a variety of different flooring overlays. As but one such example, a concrete overlay uses a thin layer of concrete over an existing concrete floor. Decorative options, such as staining or stamping, can be incorporated to achieve various aesthetic effects. Microtopping is another conventional overlay. Microtopping applies a thin layer (2 mm-4 mm) of polymer-modified cementitious material over an existing concrete floor. It creates a smooth, seamless surface that can be stained, dyed, or polished to achieve different decorative effects. Epoxy overlays are yet another option; epoxy overlays use a thin layer of epoxy resin. Epoxy overlays are known for their durability, chemical resistance, and the ability to create a glossy or matte finish.

### BRIEF DESCRIPTION OF THE DRAWINGS

FIG. 1 is a logical flow diagram of an exemplary technique for applying a cementitious overlay.

FIG. 2 is a graphical representation of an exemplary cementitious overlay.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1 Portland Cement and Calcium Aluminate Cement (CAC)

Concrete is a composite material that is composed of a “filler” (usually gravel, sand, crushed stone, or other aggregate) and a “binder” (usually Portland cement). The binder binds filler together to create a synthetic conglomerate. Concrete may additionally include “admixtures” to modify its curing and material properties (e.g., accelerants, retardants, air entraining agents, and plasticizers).

As used herein, the term “filler” (also commonly referred to as “aggregate”) refers to any chemically inert, solid bodies held together by a binder. Aggregates come in various shapes, sizes, and materials ranging from fine particles of sand to large, coarse rocks. The selection of an aggregate is determined, in part, by the desired characteristics of the concrete. For example, the density of concrete is determined by the density of the aggregate. Soft, porous aggregates can result in weak concrete with low wear resistance, while using hard aggregates can make strong concrete with a high resistance to abrasion.

As used herein, the term “binder” refers to compounds which, when chemically activated, harden around filler, to bind the filler in place. Because binder (cement) is the most expensive ingredient in making concrete, it is desirable to minimize the amount of cement used. Typically, 20% to 30% of the volume of concrete is cement.

When water is added to cement, its constituent compounds undergo a chemical process called “hydration”. Water plays a critical role in the strength of cement (and the resulting concrete). The hydration reaction consumes a specific amount of water, however concrete is usually mixed with more water than is needed for the hydration reactions. This extra water is added to give concrete sufficient workability (“flowability”). Flowing concrete is necessary to achieve proper pours, etc. Any water that is not consumed in the hydration reaction will remain in the microstructure pore space. These pores make the concrete weaker due to the lack of strong bonds. Some pores will remain no matter how well the concrete has been compacted.

Calcium aluminate cements (CAC) may be known by many other names such as aluminous cement or high alumina cement (HAC). Unlike Portland cements which are mainly based on lime-silica (calcium silicate) mineral phases, lime-alumina (calcium aluminate) compounds are the core reactive phases in CAC.

Table 1 provides a comparison of the chemical composition of different cements:

TABLE 1
Comparison of Cements

| | Cement Type | | |
|---|---|---|---|
| Cement | High | Low | Portland |
| Compound | Alumina CAC | Alumina CAC | Cement |
| Al2O3 | 39-44 | 16-18 | 6 |
| CaO | 34-38 | 10-12 | 66 |
| SiO2 | 6-8 | 65-70 | 21 |
| Fe2O3 + FeO | 12-20 | 1-2 | 3 |
| Other compounds, | Negligible | Negligible | Negligible |
| etc. | | | |

CAC undergoes multiple different reactions during hydration. Examples of such hydration processes are provided in EQNS. 1-3 below.

CA+10H CAH₁₀ (T<15° C.) EQN. 1

2CA+11H C₂AH₈+AH₃ (15° C.<T<70° C.) EQN. 2

3CA+12H C₃AH₆+2AH₃ (70° C.<T) EQN. 3
Where C: CaO, A: Al₂O₃, H: H₂O

The resulting hydrate products (CAH₁₀, C₂AH₈, C₃AH₆) are influenced by a variety of factors, such as CAC composition, particle size, water-to-cement ratio, and curing temperature. CAH₁₀ and C₂AH₈ are metastable, whereas C₃AH₆ is stable. Here, “stability” and “metastability” refers to the thermodynamic stability of a system. A stable state is at equilibrium, this means that the system is in a minimum energy configuration. A metastable state refers to an intermediate energetic state other than the system's state of least energy. Given the right conditions or a significant perturbation, a metastable system may transition to a more stable state. A more thorough discussion of CAC chemistry is discussed in Fact Sheet for Protective Coating Used to Control Concrete Corrosion, published October 2013, and incorporated herein by reference in its entirety.

Due to differences in material properties between CAC and Portland cement, CAC is generally regarded as specialty cement. CAC is used for rapid setting, high early strength, and high-temperature resistance applications. In many cases, CAC is used for sacrificial applications (where the cement is intentionally used to be consumed or degraded over time). For example, CAC may be used in the creation of sacrificial molds for metal casting (e.g., high-temperature casting). The mold is formed using the CAC material, and during the casting process, the molten metal fills the mold, solidifies, and then the CAC mold is broken away or otherwise removed to create the final metal product. CAC is also commonly used in sewer pipes and structures where their rapid setting properties are beneficial. Additionally, CAC may also be used to chemically neutralize the corrosive nature of wastewater and/or microbiological agents. This sacrificial nature helps prevent long-term damage to other structures and extends the life of the overall infrastructure.

CAC has a different manufacturing process than Portland cement. The clinker produced in the CAC manufacturing process tends to have a finer microstructure compared to some other types of cement clinkers. The finer structure assists with mixing and rapid setting. During manufacture, calcium aluminates are created by heating a mixture of limestone and bauxite to a high temperature. This process is generally carried out in a rotary kiln. The clinker produced in this process is then ground into a fine powder. The chemical reactions and phase transformations during clinkerization produce compounds with smaller crystal sizes, contributing to the overall fineness of the cement. For relative comparison, the average particle size of Portland cement is 10-50 microns; CAC has an average particle size of 1-10 microns. Importantly, ˜25 microns is the lower limit of visibility for the unassisted human eye, thus Portland cement may have some visibly granular components, whereas CAC does not.

2 Example Operation: Cement Overlays with Calcium Aluminate

Cement overlays can be applied over existing surfaces for both repair and decoration. Cement overlays provide smooth, seamless finishes without grout lines. Compared to other flooring options (e.g., epoxy, wood, laminate, ceramic, etc.), they offer a robust defense against everyday wear and tear, stains, and even chemical etching. Furthermore, cement overlays have smooth surfaces that facilitate cleaning, and their hypoallergenic nature makes them a favorable option for those with allergies or respiratory issues.

The granule size of Portland cement-based overlays greatly limits the aesthetic capability of such overlays. When brushed or accidentally disturbed, cement particles may be dragged across the surface and create visually apparent unwanted streaks. As a practical matter, most concrete overlays use “stamping” to insert patterns. Currently, certain types of aesthetic effects (swirls, waves, etc.) can only be achieved with epoxy overlays. Unfortunately, epoxy overlays are “painted” on and only provide a thin surface veneer. Epoxy overlays may also chip or peel.

CAC has certain desirable traits that makes them uniquely well-suited to cement overlay applications. The very fine particle size of CAC means that it can be spread in a smooth layer without sanding. When mixed with colorants, CAC may also be used to provide a variety of aesthetically pleasing smooth “organic” patterns (without grains or visually apparent particles). CAC may also be layered thickly (e.g., ⅛″ to 1¼″), which provides substantial strength and avoids “chipping” and “peeling” issues (common for techniques such as epoxy and microtopping).

Nonetheless, CAC is not without its challenges. CAC is extremely rapid setting; this means that large applications must be performed in a single pour (while there is a “wet” edge). Additionally, application at normal temperatures results in a metastable composition (see EQN. 2 above). Without further treatment, CAC may degrade over time. This may be further complicated by flooring substrates. Porous substrates (wood, concrete, etc.) may allow water beneath the overlay, resulting in long term deterioration.

Exemplary embodiments of the present disclosure use a “sandwich” structure to protect a CAC layer from moisture or other environmental changes that may cause deterioration. In one exemplary embodiment, the sandwich of layers includes an epoxy layer to adhere to a substrate; the epoxy may be embedded with grit to provide sufficient physical texture for a CAC layer to bond with. A CAC layer is poured over the epoxy layer; CAC provides structural strength and rigidity. In some variants, the CAC layer may also be aesthetically styled—the CAC particle size allows for brushing and other fine detail manipulations which may be particularly important to achieve organic, flow-like patterns. Finally, the topmost layer of the sandwich uses a sealant or epoxy to protect the underlying CAC layer. The topmost layer may be clear or may add layers of additional colors or other visual effects (glitter, metallic foils, etc.). While the exemplary embodiments are described in the context of a concrete substrate, the techniques may be broadly extended to other combinations of substrates, primers, and/or sealants.

More generally, various embodiments of the present disclosure are directed to overlays with cementitious materials having particle sizes that are below the visual limit of the human eye (<25 microns). While the following discussion is presented in the context of CACs which are commonly available in these particle sizes, the techniques may be broadly extended to other cement chemistries having similar physical characteristics. For example, Portland cement, if manufactured at particle sizes below 25 microns (e.g., 1 micron, 10 microns, 20 microns, etc.), might be directly substituted with CAC.

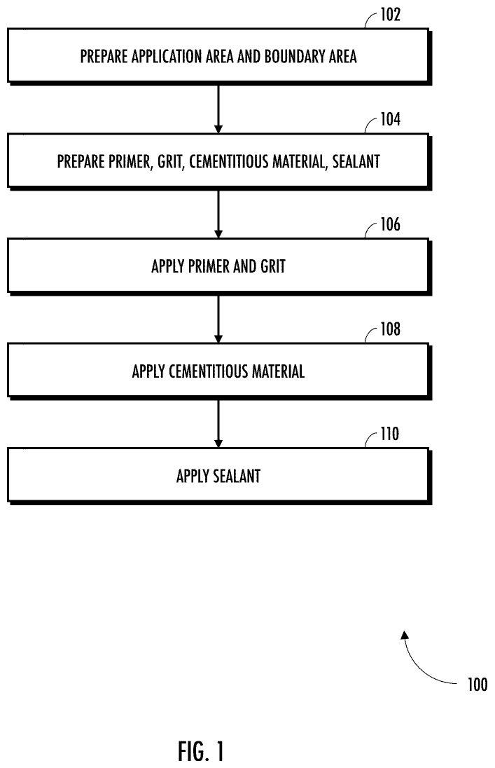

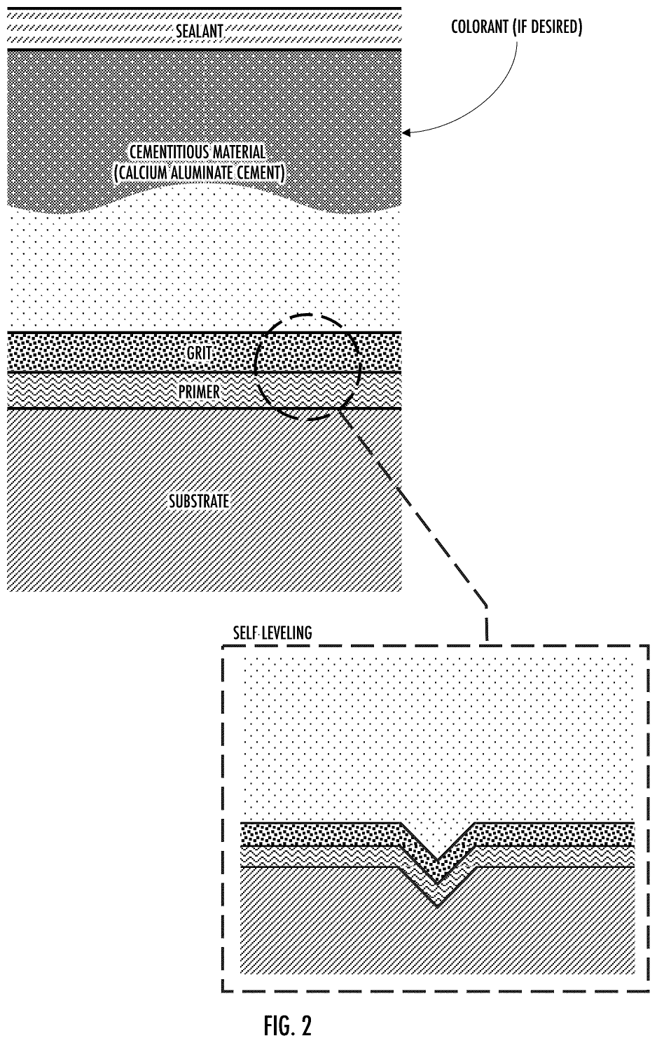

FIG. 1 is a logical flow diagram of one exemplary method for applying a cementitious overlay to a substrate, such as cement, wood, etc. FIG. 2 is a graphical representation of a calcium aluminate cement “sandwich”. As shown, the CAC layer is sandwiched between a primer and sealant; these layers ensure that the CAC correctly adheres to the substrate and protects the CAC from moisture (above and below).

At step 102, an application area and/or boundary area is prepared. As previously alluded to the hydrate products of CAC are influenced by a variety of factors; one important factor is temperature. Thus, preparations may include assessing and/or controlling the temperature of the application area to ensure that it remains between 15° C. and 25° C. (60° F.-75° F.). Similar considerations may be made for humidity (30%-50%), etc.

The application area may be cleaned of chemicals and cleared of physical debris. Boundary areas may be closed off to prevent unwanted spillage, leakage, etc. Areas may be protected with tarp and/or tape; plastic (waterproof) tapes prevent soak through. In many cases, the walls of the pour are sealed, and any holes or seams are filled-in.

The substrate of the application area may be prepared for the primer layer. For example, a concrete surface may be inspected for quality. If necessary, a concrete densifier can be applied. Concrete densifiers penetrate the surface of the concrete and fuse the inert compounds and sand particles into a crystalline bond. By bonding these loose and weak materials more tightly together, the surface density and abrasion resistance of the concrete surface is greatly increased. Similar substances may be used for e.g., epoxy, wood, laminate, ceramic, etc.

In some cases, the surface may be patched and/or leveled if desired. As used herein, the term “level” refers to a flatness tolerance of less than ¼″ every 8 feet. CAC is substantially “self-leveling”, however extremely large cracks and/or chips may result in large differences in thickness of the resulting pour. This can be particularly problematic where thickness is tightly constrained and/or where thermal contraction and expansion is a concern.

In some cases, the substrate surface may be textured to improve adhesion. As but one such example, finished concrete may have a layer of “cream” that is mostly cement, rather than aggregate. The surface cream may be ground off to expose the underlying aggregate for proper adhesion.

At step 104, a primer, a grit, a cementitious material, and a sealant is prepared. As previously alluded to, CAC is rapid setting (relative to Portland cement). The type and amount of each material should be procured. Colorants, if desired, may be mixed with the CAC. In some cases, the materials may also be placed (staged) so they are ready for use during the pour.

At step 106, the primer and the grit are applied to the application area. In one exemplary embodiment, the primer is epoxy. Epoxy (or epoxide, generally) is a type of polymer. Epoxides are highly reactive groups of molecules that harden (or cure) through chemical reactions or temperature. Epoxy provides both adhesion for grit and protection from moisture (for the subsequently applied CAC layer). More generally, any substance that ensures proper adhesion of CAC to the substrate, protects the CAC from moisture, and provides additional protection for the CAC layer, may be substituted with equal success.

Two-part epoxies are composed of a resin (often called the “steel”) and a hardener; the resin is mixed with the hardener. The resulting chemical reaction causes the epoxy to transform from a thick liquid to a putty and eventually a fully cured and hardened material. Heat-cured epoxies use high temperature to cure (often more than 100° C., 200° F.).

Paint rollers may be used to apply epoxy. The pile height, or “nap”, refers to the width of the fabric/material of the roller. A ½″ nap roller can be used for most concrete substrates. Other substrates (e.g., epoxy, wood, laminate, ceramic, etc.) may use shorter or longer naps. Other suitable applications may use brush, spray, etc.

Grit may be added before the primer sets-ideally, the grit is embedded within the epoxy. Any free residual grit should be removed. The process may be repeated to ensure sufficiently uniform coverage. The grit provides sufficient texture for the CAC to adhere; 60 grit is sufficient for most CACs.

Standard grit sizes are defined by organizations such as the Coated Abrasive Manufacturers Institute (CAMI) in the U.S. and the Federation of European Producers of Abrasives (FEPA) in Europe. These standards provide a consistent measurement of abrasive particle sizes for sanding, grinding, and polishing applications.

Table 2 provides a comparison of the average particle size for different grades of grit:

TABLE 2
Average Particle Size of Selected Grit Grades

| | | |
|---|---|---|
| Grit | CAMI | FEPA |

| | | | | |
|---|---|---|---|---|
| 12 | ~1680 | microns | ~1815 | microns |
| 24 | ~710 | microns | ~765 | microns |
| 60 | ~250 | microns | ~269 | microns |
| 120 | ~125 | microns | ~115 | microns |
| 240 | ~63 | microns | ~58 | microns |
| 600 | ~25.8 | microns | ~26 | microns |
| 1200 | ~9 | microns | ~15 | microns |
| 2400 | ~6.5 | microns | ~7 | microns |

At step 108, the cementitious material (CAC) is applied to the application area. CAC is mixed with water and colorants (if desired). Water may be adjusted to change the consistency of the resulting paste. Once the CAC is poured and shaped, it may cure for 12-24 hours. Cure times are based on temperature and humidity. These cure times assume 60-75 degrees Fahrenheit, standard humidity (30%-50%).

In some cases, the CAC may be aesthetically styled before curing. The consistency of the CAC may be used to swirl and/or feather various colorants to achieve different looks. Notably, the very fine CAC particle size avoids visible lines or clumps. Furthermore, the colorants are embedded throughout the CAC layer (e.g., cannot be chipped off).

Cured CAC generates significant dust, so after curing, the CAC layer may be thoroughly cleaned of any residual dust and protected from contact with water before the sealing step.

At step 110, the sealant is applied to the application area. Sealant may be applied in multiple applications. Each application may require curing. In one exemplary implementation, sealants may be applied in 3 coats with a 2-3 hour curing time between applications. In some variants, the sealant may be finished according to desired sheen and texture (e.g., anti-slip traction). For example, aluminum oxide may be added to the sealant and quickly back-rolled to avoid roller lines. Cure times are based on temperature and humidity. These cure times assume 60-75 degrees Fahrenheit, standard humidity (30%-50%). More generally, any substance that protects the CAC from moisture may be substituted with equal success.

In one specific implementation, the sealant is a polyaspartic sealant. Polyaspartic sealants are typically a two-part system of a polyurea base coat (a polyurea coating is a type of protective coating made from a combination of isocynate and resin) and an aliphatic polyaspartic top coat. The polyurea base coat strongly bonds the flooring surface, while the polyaspartic top coat provides a glossy finish.

More generally, a sealant is a protective coating that protects against environmental exposure (e.g., moisture, chemicals, abrasion, radiation (UV), etc.). Polyaspartic sealants are generally more expensive than epoxy sealants, but they offer faster curing times, thinner applications, and do not “yellow” from UV exposure—these features minimally affect the aesthetic of the sealed layer, which may be important to preserve the aesthetic features described above. However, epoxy sealants may be substituted with equal success where aesthetics are less important; epoxy sealants are more cost effective relative to polyaspartic sealants, and can be made with thicker layers (improving durability), and slower cure times (extending handling times while curing), and may be made in a variety of formulations for other environmental considerations (resistance to e.g., acids, solvents, temperature, etc.).

APPENDIX A details one specific step-by-step process for pouring a CAC overlay.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

1. A method for applying a cementitious overlay, comprising:
preparing an application area;
preparing an epoxy primer, a grit, a cementitious material, and a polyaspartic sealant;
applying the epoxy primer and the grit to create a first layer over the application area;
applying the cementitious material to create a second layer over the first layer; and
applying the polyaspartic sealant to create a third layer over the second layer.

2. The method of claim 1, where the cementitious material has an average particle size below 25 microns.

3. The method of claim 2, further comprising mixing a first colorant with a first portion of the cementitious material.

4. The method of claim 3, further comprising styling the first portion of the cementitious material into a second portion of the cementitious material.

5. The method of claim 4, further comprising mixing a second colorant with the second portion of the cementitious material.

6. The method of claim 4, where the average particle size of the cementitious material avoids visible lines or clumps when styling the first portion.

7. The method of claim 2, where the average particle size of the cementitious material enables self-leveling when applying the cementitious material to create the second layer over the first layer.

8. A cementitious overlay, comprising:
a first layer;
a cementitious material layer having a first average particle size below 25 microns; and
a second layer where the cementitious material layer is sandwiched between the first layer and the second layer.

9. The cementitious overlay of claim 8, where the first layer comprises an epoxy primer layer and the second layer comprises a polyaspartic sealant layer.

10. The cementitious overlay of claim 9, where the cementitious material layer further comprises a first portion having a first colorant and a second portion having a second colorant.

11. The cementitious overlay of claim 10, where the first portion and the second portion are visible through the polyaspartic sealant layer.

12. The cementitious overlay of claim 10, further comprising grit interspersed between the first layer and the cementitious material layer, the grit having a second average particle size greater than 25 microns.

13. The cementitious overlay of claim 8, where the cementitious material layer comprises calcium aluminate.

14. The cementitious overlay of claim 8, where the cementitious material layer comprises calcium silicate.

15. A cementitious overlay produced by a process comprising:
applying an epoxy primer in a first layer over an application area;
applying a cementitious material having an average particle size below 25 microns to create a second layer over the first layer; and
applying a polyaspartic sealant to create a third layer over the second layer.

16. The cementitious overlay of claim 15, where the process further comprises mixing a first colorant with a first portion of the cementitious material.

17. The cementitious overlay of claim 16, where the process further comprises styling the first portion of the cementitious material into a second portion of the cementitious material.

18. The cementitious overlay of claim 17, where the process further comprises mixing a second colorant with the second portion of the cementitious material.

19. The cementitious overlay of claim 15, where the epoxy primer is applied with a ½ inch nap roller.

20. The cementitious overlay of claim 18, where the process further comprises interspersing 60 grit sand into the epoxy primer.
